(19) United States
(12) Patent Application Publication
(10) Pub. No.: US 2026/0210363 A1
(43) Pub. Date: Jul. 23, 2026

(54) SUBMERSIBLE PUMPING SYSTEM WITH MOTOR PROTECTOR HAVING ENHANCED COOLING

(71) Applicant: SCHLUMBERGER TECHNOLOGY CORPORATION, Sugar Land, TX (US)

(72) Inventors: Pradeep MAHADEVAN, Singapore (SG); Raju EKAMBARAM, Singapore (SG); Stanislav Konstantinovich IVANOV, Singapore (SG); You Cheng JEE, Singapore (SG)

(21) Appl. No.: 19/141,063

(22) PCT Filed: Jan. 3, 2024
(86) PCT No.: PCT/US2024/010096

§ 371 Date: Jun. 19, 2025

(30) Foreign Application Priority Data
Jan. 6, 2023 (SG) 10202300050X

(51) Int. Cl. F04D 13/10; E21B 36/00; E21B 43/12; F04D 29/041; F04D 29/58

(52) U.S. Cl. CPC F04D 13/10; E21B 36/001; E21B 43/128; F04D 29/5813; F04D 29/041

(57) ABSTRACT

A technique facilitates cooling of a motor protector which may be used in an electric submersible pumping system having a submersible pump powered by a submersible motor. The motor protector may be constructed with a plurality of thrust bearing chambers which can be at least partially filled with an internal motor fluid. Each thrust bearing chamber has a thrust bearing positioned to absorb loads generated during operation of the submersible pump. Additionally, the motor protector comprises an enhanced cooling system to facilitate improved removal of heat created at the thrust bearings. The enhanced cooling system may comprise various components which help transfer heat away from the thrust bearing chambers.

### CROSS REFERENCE TO RELATED REFERENCES

This application claims the benefit of Singapore Provisional Application No. 10202300050X filed Jan. 6, 2023, the entire contents of which are herein incorporated by reference in their entirety.

### BACKGROUND

In many hydrocarbon well applications, electric submersible pumping (ESP) systems are used for pumping fluids, e.g. hydrocarbon-based fluids. For example, the ESP system may be conveyed downhole and used to pump oil from a downhole wellbore location to a surface collection location along a production tubing. The ESP system comprises various components, including a submersible pump, a submersible motor operated to power the submersible pump, and a motor protector which enables pressure balancing of internal motor fluid with the surrounding environment. In various applications, the motor protector also contains a thrust bearing or bearings which counter the thrust created during operation of the submersible pump.

As the speed of operation of ESP systems increases, thrust bearing load capacity becomes more of a consideration, particularly when using high down thrust pump components, such as multi-phase gas handlers. The effective load capacity of a given thrust bearing also may decrease due to resulting excessive shear and decreased viscosity of the internal motor fluid in the thrust bearing chamber. Consequently, a plurality of thrust bearings, e.g. dual thrust bearings, may be employed to counteract the thrust generated. However, the faster speeds and/or higher thrusts can create substantial heat at the thrust bearings. Existing systems have difficulty dissipating the substantial heat created in the motor protector.

### SUMMARY

In general, a system and methodology facilitate cooling of a motor protector which may be used in an electric submersible pumping system having a submersible pump powered by a submersible motor. According to an embodiment, the motor protector may be constructed with a plurality of thrust bearing chambers which are at least partially fillable with an internal motor fluid. Each thrust bearing chamber has a thrust bearing positioned to absorb loads generated during operation of the submersible pump. Additionally, the motor protector comprises an enhanced cooling system to facilitate improved removal of heat created at the thrust bearings. The enhanced cooling system may comprise various components which help transfer heat away from the thrust bearing chambers. By way of example, such components may comprise an inducer enclosed by inducer body having external grooves oriented to move hot internal motor fluid against an external motor protector housing, thus enabling improved transfer of heat to well fluid flowing along the exterior of the motor protector housing.

However, many modifications are possible without materially departing from the teachings of this disclosure. Accordingly, such modifications are intended to be included within the scope of this disclosure as defined in the claims.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 is a schematic illustration of a well system comprising an example of an electric submersible pumping system having a motor protector, according to an embodiment of the disclosure;

FIG. 2 is a cross-sectional view of an example of a motor protector, according to an embodiment of the disclosure;

FIG. 3 is a cross-sectional view of an expanded portion of the motor protector illustrated in FIG. 2, according to an embodiment of the disclosure;

FIG. 4 is an orthogonal view of an example of a portion of the motor protector including an inducer body having external grooves, according to an embodiment of the disclosure;

FIG. 5 is an orthogonal view of an example of a motor protector body structure to which the inducer body, illustrated in FIG. 4, may be attached, according to an embodiment of the disclosure;

FIG. 6 is a cross-sectional view of a portion of the motor protector showing a coupling between the inducer body and the motor protector body structure, according to an embodiment of the disclosure;

FIG. 7 is an orthogonal view of a portion of a motor protector housing with an example of enhanced heat transfer features, according to an embodiment of the disclosure;

FIG. 8 is an orthogonal view of a portion of a motor protector housing with another type of enhanced heat transfer features, according to an embodiment of the disclosure;

FIG. 9 is a cross-sectional view of a portion of the motor protector showing an example of components with enhanced heat transfer features, according to an embodiment of the disclosure;

FIG. 10 is an orthogonal view of the motor protector showing an example of components with enhanced heat transfer features, according to an embodiment of the disclosure;

FIG. 11 is a cross-sectional view of the motor protector showing an example of components with enhanced heat transfer features, according to an embodiment of the disclosure;

FIG. 12 is a cross-sectional view of an example of the motor protector having a plurality of thrust bearing chambers, e.g. dual thrust bearing chambers, with thrust bearings having different capacities and different diameters relative to each other, according to an embodiment of the disclosure;

FIG. 13 is a cross-sectional view of another example of the motor protector having a plurality of thrust bearing chambers, e.g. dual thrust bearing chambers, with thrust bearings having different capacities and different diameters relative to each other, according to an embodiment of the disclosure; and

FIG. 14 is a cross-sectional view of another example of the motor protector having a plurality of thrust bearing chambers, e.g. dual thrust bearing chambers, with thrust bearings having different capacities and different diameters relative to each other, according to an embodiment of the disclosure.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

The present disclosure generally relates to a system and methodology which facilitate cooling of a motor protector. Motor protectors may be used in a variety of pumping systems including electric submersible pumping systems deployed downhole for pumping well fluids. Electric submersible pumping systems may have many types of system components but often include at least a submersible pump, a submersible motor to power the submersible pump, and a motor protector to protect the motor and provide pressure balancing.

According to an embodiment, the motor protector may be constructed with a plurality of thrust bearing chambers which are at least partially fillable with an internal motor fluid. Each thrust bearing chamber has a thrust bearing positioned to absorb loads generated during operation of the submersible pump. Additionally, the motor protector comprises an enhanced cooling system to facilitate improved removal of heat created at the thrust bearings. The enhanced cooling system may comprise various components which help transfer heat away from the thrust bearing chambers and into the surrounding well fluid.

By way of example, such enhanced heat transfer components may comprise an inducer enclosed by inducer body having external grooves oriented to move hot internal motor fluid against an external motor protector housing. As the hot internal motor fluid moves against the interior of the motor protector housing, heat is transferred through the housing and into well fluid flowing along the exterior of the motor protector housing. The well fluid is thus used to carry heat away from the motor protector. As described in greater detail below, however, the motor protector may utilize a variety of additional and/or other components to enhance the removal of heat.

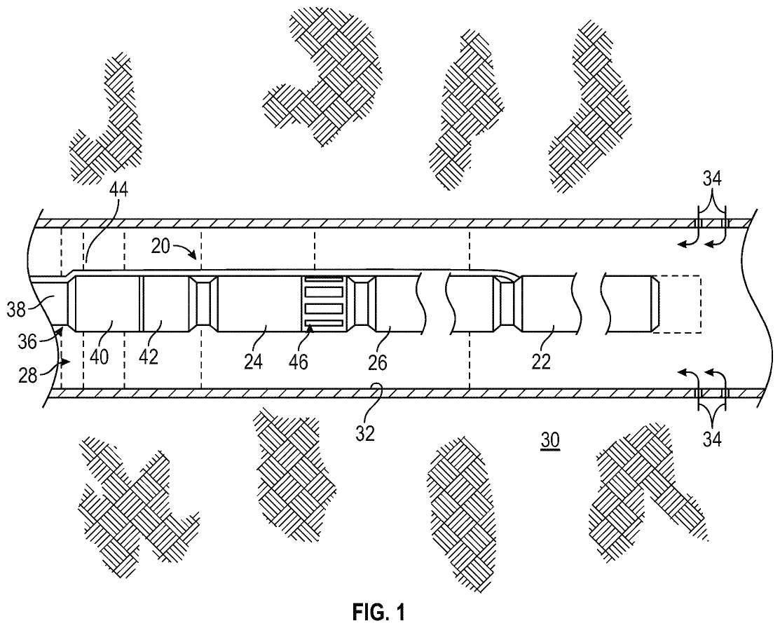

Referring generally to FIG. 1, an example of a submersible pumping system 20 is illustrated as deployed in a well-related application. In this embodiment, the submersible pumping system 20 is an electric submersible pumping system of the type that is sometimes used to pump oil and/or other well fluids. However, the illustrated embodiment is simply provided as an example of numerous potential embodiments that may be deployed downhole or used in other types of environments for pumping fluid.

The submersible pumping system 20 may have many types of components depending on the particular well application and/or environment in which it is used. For example, the submersible pumping system 20 may comprise a submersible motor 22 which works in cooperation with at least one submersible pump 24 and a motor protector 26. It should be noted the motor protector 26 enables pressure balancing of the internal motor fluid of submersible motor 22 with respect to the surrounding environment. The submersible motor 22, submersible pump 24, and motor protector 26 are coupled together into electric submersible pumping (ESP) system 20 via suitable connectors, such as flange connectors. In some embodiments, a plurality of submersible motors 22 and/or submersible pumps 24 may be employed.

The submersible pumping system 20 may be deployed in a wellbore 28 drilled into a geologic formation 30 containing, for example, desirable production fluids such as hydrocarbon-based fluids. In some applications, the electric submersible pumping system 20 may be positioned vertically in a vertical section of wellbore 28 but in other applications electric submersible pumping system 20 may be positioned in a deviated, e.g. horizontal, sectional wellbore 28. It should be noted wellbore 28 may comprise various types of boreholes used for production, injection, or other pumping operations.

In some applications, the wellbore 28 may be lined with a wellbore casing 32 which may be perforated with a plurality of perforations 34 extending through the casing 32 and into the surrounding formation 30. The perforations 34 enable flow of fluids between the surrounding formation 30 and the wellbore 28.

The submersible pumping system 20 may be deployed downhole into wellbore 28 via a conveyance 36. The conveyance 36 may have a variety of configurations and may comprise a tubing 38, e.g. coiled tubing or production tubing. However, other suitable conveyances, such as wireline or slick line, also may be used to deploy submersible pumping system 20. The conveyance 36 may be coupled with submersible pumping system 20 by an appropriate connector 40 which may comprise or may be coupled with a discharge head 42 which receives and discharges fluid pumped by submersible pump 24.

Electric power may be provided to submersible motor 22 via a power cable 44 which extends along conveyance 36 and submersible pumping system 20 for connection with submersible motor 22. The submersible motor 22, in turn, powers submersible pump 24 which then draws in fluid from wellbore 28 through a pump intake 46. By way of example, the submersible motor 22 may power submersible pump 24 via a shaft used to rotate at least one impeller within the submersible pump 24.

Within submersible pump 24, for example, a plurality of impellers may be rotated by submersible motor 22 to pump fluid from intake 46, through submersible pump 24, and out through the discharge head 42. The discharged fluid may be directed along an interior of tubing 38 (or along another suitable flow path) to a desired location, such as a collection location at the surface. However, various other components and system configurations may be utilized in a variety of pumping operations and environments.

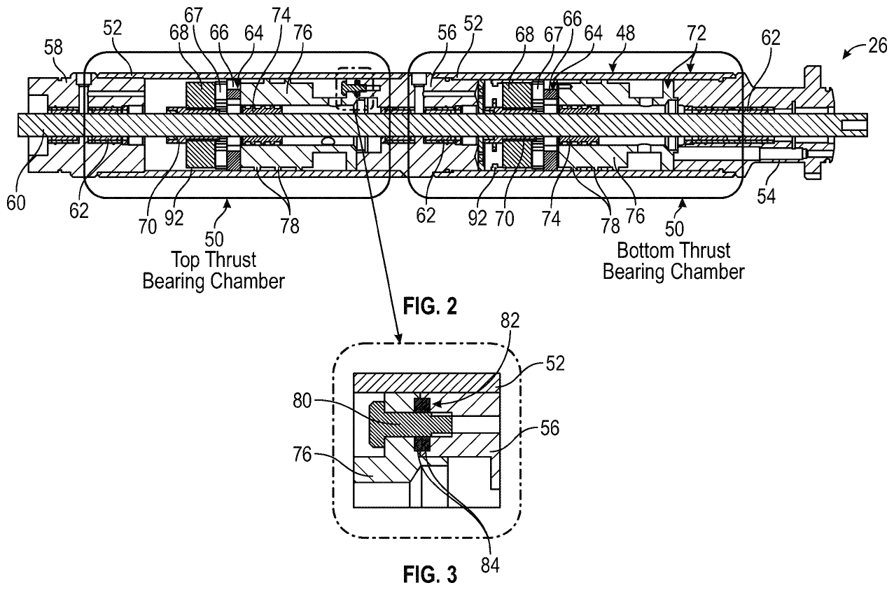

Referring generally to FIG. 2, an embodiment of motor protector 26 is illustrated. In this embodiment, the motor protector 26 is illustrated in cross-section and comprises a motor protector housing 48 which establishes, e.g. encloses, a plurality of thrust bearing chambers 50. In the example illustrated, the motor protector 26 is a dual thrust bearing chamber design but some embodiments may utilize a single thrust bearing chamber 50 or at least three thrust bearing chambers 50.

By way of example, the motor protector housing 48 may be constructed with a plurality of motor protector housing sections 52 which may be generally tubular in shape. As illustrated, each motor protector housing section 52 may be positioned to enclose a corresponding thrust bearing chamber 50 and may be connected to structural components of the motor protector 26. For example, one of the motor protector housing sections 52 may be connected between a motor protector base 54 and an intermediate body 56.

Similarly, the other motor protector housing section 52 may be connected between the motor protector intermediate body 56 and a motor protector head 58.

A motor protector shaft 60 may be positioned longitudinally through the motor protector housing 48. The motor protector shaft 60 is rotatably mounted in corresponding bearings 62, e.g. radial bearings, located in, for example, base 54, intermediate body 56, and head 58.

Each of the thrust bearing chambers 50 may contain an internal motor fluid, e.g. oil, and encloses a thrust bearing 64. Each thrust bearing 64 may have various configurations which include, for example, a thrust bearing pad 66, affixed within the motor protector housing 48, a thrust bearing spacer 67, and a thrust bearing runner 68 connected to the shaft 60 via a suitable coupler 70. During operation of electric submersible pumping system 20, shaft 60 is rotated and the thrust bearing runner 68 is thus rotated against the thrust bearing pad 66/spacer 67.

The rotation of thrust bearing runner 68 against the thrust bearing pad 66/spacer 67 creates substantial heat which is transferred into the internal motor fluid. The substantial heat can be detrimental to the internal motor fluid and to the components of both the motor protector 26 and the submersible motor 22. To enhance the removal of this unwanted, excess heat, motor protector 26 incorporates an enhanced cooling system 72 which may comprise components in each of the thrust bearing chambers 50.

By way of example, the enhanced cooling system 72 may comprise in each thrust bearing chamber 50 an inducer 74 enclosed by an inducer body 76 having external grooves 78, e.g. helical grooves. Each inducer 74 may be mounted to shaft 60 so as to rotate with the shaft 60 and induce flow of internal motor fluid through the interior of the motor protector 26. Each corresponding inducer body 76 may be mounted to a corresponding structural component of the motor protector 26. For example, the lower inducer body 76 may be bolted or otherwise secured to motor protector base 54.

Similarly, the upper inducer body 76 may be bolted or otherwise secured to intermediate body 56.

One example of a technique for securing inducer body 76 to, for example, intermediate body 56 is illustrated in FIG. 3. With this type of technique, the inducer body 76 is secured to intermediate body 56 via a plurality of bolts 80, e.g. three bolts. A spring member 82 may be positioned at each bolt 80 to provide a slightly flexible mount so as to ensure a degree of protective resilience during operation. By way of example, each spring member 82 may comprise a plurality of Belleville washers 84 which are stacked along the corresponding bolt 80. The desired spring resistance may dictate the use of different numbers of Belleville washers 84 (or other types of spring members) such as the two Belleville washers 84 in FIG. 3 or the three Belleville washers 84 illustrated in FIG. 6. The same type of securing technique may be used for one or both of the inducer bodies 76.

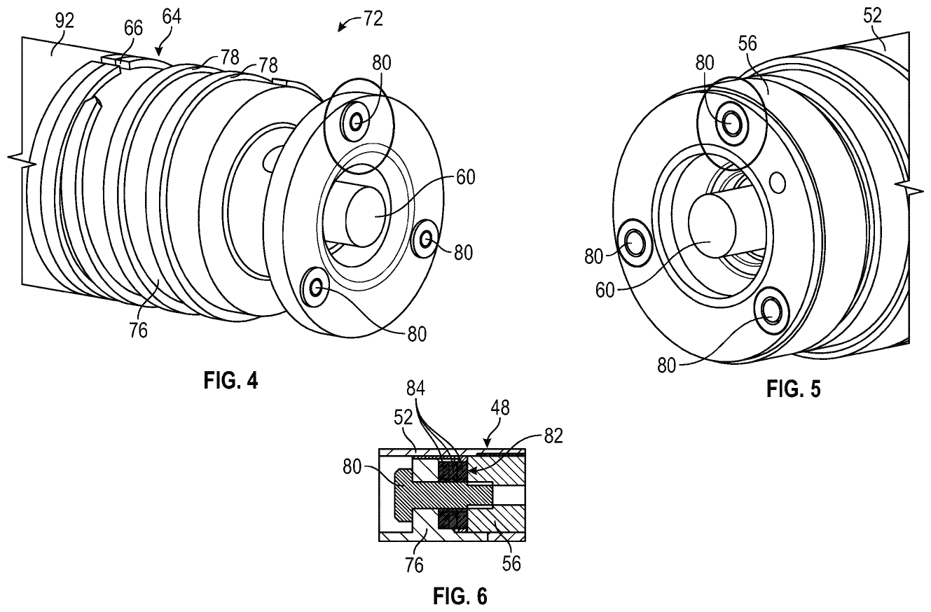

With additional reference to FIGS. 4-6, the external grooves 78 may be located along an outer surface of the inducer body 76 and oriented to move the internal motor fluid against the motor protector housing 48 so as to facilitate heat transfer through the motor protector housing 48. Effectively, the external grooves 78 help direct hot internal motor fluid along an interior surface of the motor protector housing 48 so the motor protector housing 48 is better able to transfer heat out of the motor protector 26. During operation, this outward heat flow through the motor protector housing 48 transfers into the well fluid flowing along the exterior of the motor protector housing 48. In this manner, the flow of well fluid along the exterior of electric submersible pumping system 20 may be used to carry away excess heat and to further improve the removal of heat from motor protector 26.

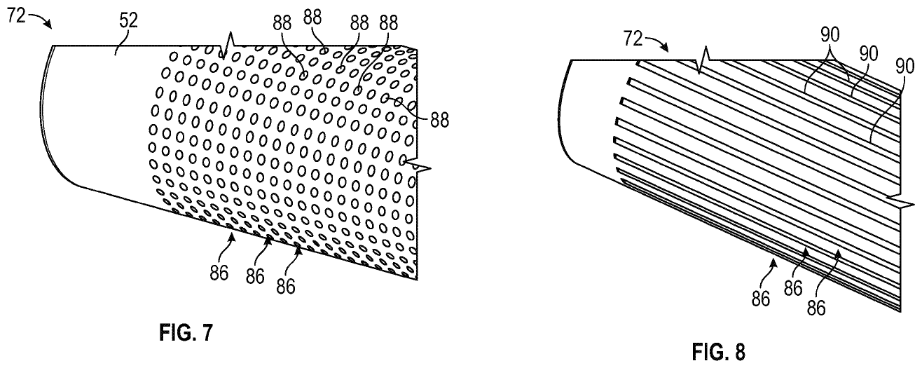

Referring generally to FIGS. 7-8, the enhanced cooling system 72 also may comprise additional or alternate features incorporated into motor protector housing 48.

For example, the enhanced cooling system 72 may comprise depressions 86 in the motor protector housing 48 to increase the effective heat transfer area, e.g. the heat transfer area exposed to the external well fluid and/or to the internal motor fluid. The depressions 86 may be located along the exterior and/or interior of the motor protector housing 48 and may comprise a variety of shapes and configurations. By way of example, the depressions 86 may comprise dimples 88, as illustrated in FIG. 7, or longitudinal grooves 90, as illustrated in FIG. 8. When the depressions 86 are formed along the outside diameter of housing 48, the effective area exposed well fluid is increased and this enhances the heat transfer between the recirculating internal motor fluid and the external well fluid.

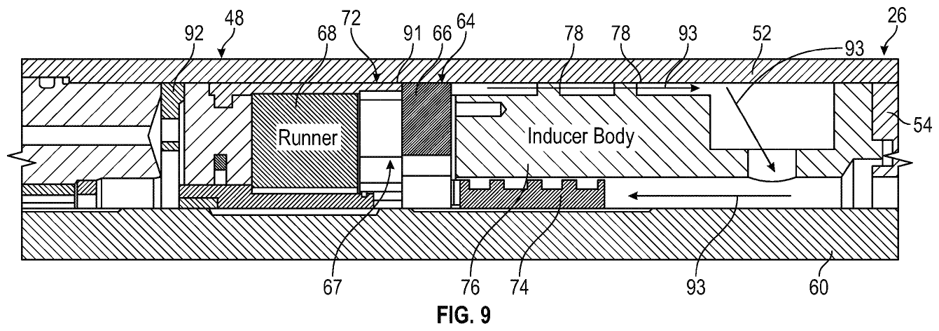

According to another example, the enhanced cooling system 72 may comprise utilizing components constructed with materials having higher thermal conductivity and higher coefficient of thermal expansion so as to ensure enhanced thermal contact between adjacent components. The enhanced thermal contact results in increased heat transfer and improved cooling. As illustrated in FIG. 9, for example, the thrust bearing spacer 67 may be assembled with a close tolerance inside a surrounding thrust bearing housing 91 and constructed with a material having a higher coefficient of thermal expansion than the thrust bearing housing 91. It should be noted the thrust bearing spacer 67 as well as runner 68 may be held in place by a lock ring 92 or other suitable device.

According to an embodiment, the thrust bearing housing 91 may be constructed from a steel material, e.g. carbon steel, and the thrust bearing spacer 67 may be constructed from a material such as bronze or brass which has a higher coefficient of thermal expansion than steel. At operating temperatures, the material of thrust bearing spacer 67 expands more than the material of thrust bearing housing 91 creating increased contact pressure between the outside diameter of thrust bearing spacer 67 and the surrounding thrust bearing housing 91. This increased contact pressure creates a corresponding increase in heat transfer so as to improve the transfer of heat to the surrounding motor protector housing 48 and into the external, flowing well fluid.

Effectively, the technique enhances heat transfer from the internal motor fluid, through the high contact pressure components, through the motor protector housing section 52, and into the surrounding well fluid. It should be noted that during operation of motor protector 26 (and inducers 74) hot internal motor fluid is circulated as indicated by arrows 93.

Other components, such as the inducer body 76, also may be constructed from materials having higher conductivity and higher coefficients of thermal expansion. The increased conductivity and increased contact pressure with adjacent components help to carry away more heat from the corresponding thrust bearing chamber 50 and to transfer that heat to the well fluid. This type of enhanced heat transfer can be particularly useful during transient operation, e.g. during short-term low flow or no flow conditions, where increased heat transfer from the region of the thrust bearing 64 is highly desirable.

In some embodiments, the enhanced cooling system 72 may comprise enlarged components to again increase the area available for heat transfer. For example, the diameters of various components, such as the motor protector base 54, intermediate body 56, motor protector head 58, and housing 48 may be increased for some operation so as to facilitate enhanced heat transfer. Existing motor protectors sometimes use a relatively smaller diameter compared to adjacent components of the submersible pumping system so as to provide space for a motor lead extension (MLE) which provides electrical power to submersible motor 22. However, the smaller diameter components limit heat transfer.

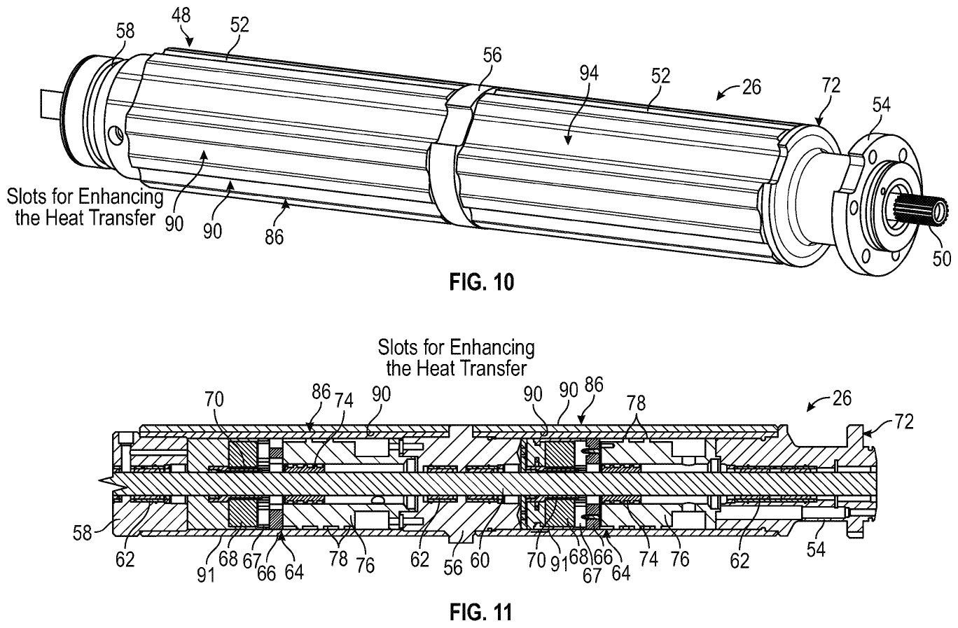

As illustrated in FIGS. 10 and 11, the motor protector 26 described herein may employ enlarged diameter components, e.g. enlarged base 54, intermediate body 56, motor protector head 58, housing 48, which are provided with an MLE slot 94. In this manner, the component diameters can be expanded while room is provided for routing the MLE within the outer diameter via MLE slot 94. As a result, the surface area for heat transfer is increased and enhanced cooling of the motor protector 26 is achieved. As illustrated in FIGS. 10 and 11, depressions 86 in the form of slots 90 or other suitable depressions may be formed along both the exterior and interior of motor protector housing 48 to further enhance the removal of heat.

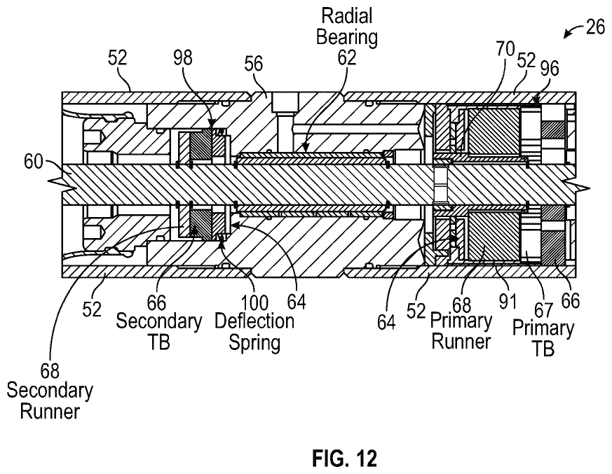

Referring generally to FIGS. 12-14, some embodiments of motor protector 26 may utilize thrust bearings 64 which have relatively different sizes, e.g. different diameters, and different capacities. In a dual thrust bearing style motor protector 26, for example, the thrust bearings 64 may be constructed as a primary thrust bearing 96 and a secondary thrust bearing 98. The secondary thrust bearing 98 has a lower capacity and hence a relatively smaller footprint (e.g. smaller diameter) compared to the primary thrust bearing 96. With this type of arrangement, the secondary thrust bearing 98 may be sized to simply handle the weight resting on shaft 60 and motor protector 26. Such weight may include the weight of other features throughout the submersible pumping system 20 such as the weight of other component shafts, internal pump components, other fluid handling equipment, and/or other features/parts which add to the weight resting on shaft 60.

Due to the smaller capacity lifting requirements of the secondary thrust bearing 98, it can be located at a variety of available spaces within the motor protector 26. By way of example, the secondary thrust bearing 98 may be located above the primary thrust bearing 96 within the intermediate body 56, as illustrated in FIG. 12. In this example, the secondary thrust bearing 98 includes a deflection spring 100 which provides a secondary lifting mechanism appropriate for the lower load capacity of secondary thrust bearing 98. The deflection spring 100 may be in the form of a wave spring, Belleville washers, magnetic repulsion, hydraulic spring, pneumatic spring, or other suitable type of spring member.

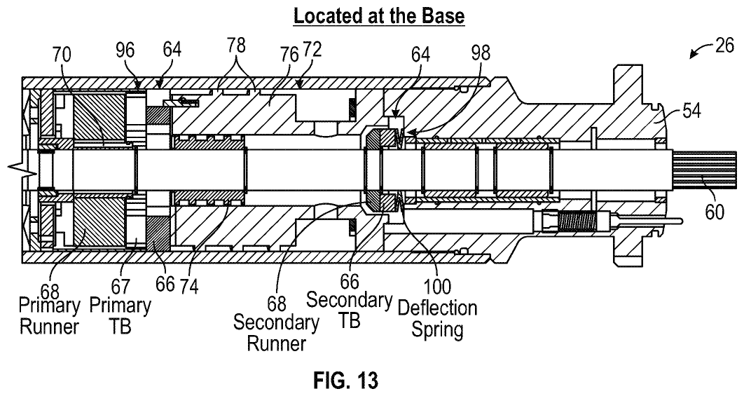

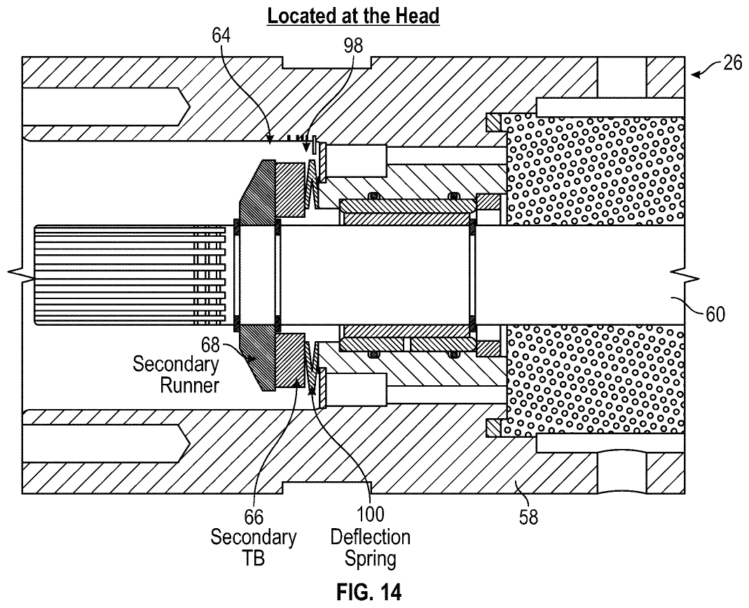

According to another example, the secondary thrust bearing 98 may be located below the primary thrust bearing 96 within the motor protector base 54, as illustrated in FIG. 13. In another embodiment, the secondary thrust bearing 98 may be located above the primary thrust bearing 96 within the motor protector head 58, as illustrated in FIG. 14. The smaller capacity, and thus the smaller size/diameter, of secondary thrust bearing 98 facilitates placement of the secondary thrust bearing 98 at a variety of locations within the motor protector 26.

Depending on the parameters of a given application and/or environment, embodiments described herein may achieve the desired, enhanced heat transfer characteristics via individual components described herein or various combinations of the heat transfer components and techniques. Additionally, the motor protector 26 may have different sizes, different types of thrust bearings, different numbers of thrust bearing chambers, different types of inducers or other internal motor fluid circulation devices, and/or various other features. Furthermore, the features and configuration of the motor protector 26 may be selected according to its intended use in a variety of oilfield related pumping operations or other types of pumping operations.

The overall submersible pumping system 20 also may be adjusted to accommodate many types of pumping applications. For example, the submersible pumping system 20 may be in the form of an electric submersible pumping system combined with other components for use in a wellbore or other type of borehole.

Similarly, the number and arrangement of submersible motors 22, submersible pumps 24, and motor protectors 26 may vary to achieve a desired pumping capability in a given environment.

Although a few embodiments of the disclosure have been described in detail above, those of ordinary skill in the art will readily appreciate that many modifications are possible without materially departing from the teachings of this disclosure.

Accordingly, such modifications are intended to be included within the scope of this disclosure as defined in the claims.

What is claimed is:

1. A system for use in pumping fluid, comprising:
an electric submersible pumping system having a submersible pump, a submersible motor powering the submersible pump, and a motor protector, the motor protector comprising:
a motor protector housing establishing a plurality of thrust bearing chambers comprising internal motor fluid, each thrust bearing chamber having a thrust bearing and an enhanced cooling system to facilitate removal of heat created at the thrust bearing, the enhanced cooling system comprising an inducer enclosed by an inducer body with external grooves oriented to move the internal motor fluid against the motor protector housing to enhance cooling via a well fluid flowing along the exterior of the motor protector housing.

2. The system as recited in claim 1, wherein the enhanced cooling system further comprises depressions in the motor protector housing to increase an effective heat transfer area.

3. The system as recited in claim 2, wherein the depressions comprise dimples in an exterior of the housing.

4. The system as recited in claim 2, wherein the depressions comprise grooves in an exterior of the housing.

5. The system as recited in claim 1, wherein the enhanced cooling system further comprises adjacent components constructed from materials having different coefficients of thermal expansion so as to create greater contact pressure, and thus greater thermal conductance, between the adjacent components as a temperature increases.

6. The system as recited in claim 5, wherein the adjacent components comprise a thrust bearing spacer and a thrust bearing housing.

7. The system as recited in claim 5, wherein the adjacent components comprise the inducer body formed of a material having a higher coefficient of thermal expansion than the motor protector housing.

8. The system as recited in claim 1, wherein the enhanced cooling system further comprises a motor lead extension slot formed along the motor protector housing to accommodate a motor lead extension when expanding a diameter of the motor protector housing to a maximum diameter of the electric submersible pumping system so as to increase an effective heat transfer area of the motor protector housing.

9. The system as recited in claim 1, wherein the plurality of thrust bearing chambers comprises two thrust bearing chambers, the thrust bearing in one of the thrust bearing chambers being of a lower capacity and a smaller diameter than the thrust bearing in the other of the thrust bearing chambers.

10. A method of heat transfer, the method comprising:
providing an electric submersible pumping system with a submersible pump, a submersible motor powering the submersible pump, and a motor protector;
using the motor protector to counter thrust exerted during operation of the submersible pump by utilizing a plurality of thrust bearing chambers with each thrust bearing chamber having a thrust bearing operable within internal motor fluid; and
protecting the motor protector from heat generated by the thrust bearings via an enhanced cooling system which facilitates removal of heat by flowing the motor protector oil along external grooves in an inducer body, the external grooves being oriented to move the internal motor fluid against a motor protector housing and to thus enhance the heat transfer to a well fluid flowing along the exterior of the motor protector housing.

11. The method as recited in claim 10, wherein utilizing the plurality of thrust bearing chambers comprises utilizing two thrust bearing chambers with the thrust bearing in one of the thrust bearing chambers being of a lower capacity and a smaller diameter than the thrust bearing in the other of the thrust bearing chambers.

12. The method as recited in claim 10, wherein protecting the motor protector from heat further comprises using depressions in a motor protector housing to increase an effective heat transfer area.

13. The method as recited in claim 12, wherein using depressions comprises using depressions along an exterior of the motor protector housing.

14. The method as recited in claim 12, wherein using depressions comprises using depressions along an interior of the motor protector housing.

15. The method as recited in claim 10, wherein protecting the motor protector from heat further comprises constructing adjacent components of the motor protector from materials having different coefficients of thermal expansion so as to create greater contact pressure, and thus greater thermal conductance, between the adjacent components as a temperature increases.

16. The method as recited in claim 12, wherein using the depressions comprises using dimples in an exterior of the housing.

17. The method as recited in claim 12, wherein using the depressions comprises using grooves in an exterior of the housing.

18. The method as recited in claim 15, wherein constructing the adjacent components comprises constructing a thrust bearing spacer and a thrust bearing housing.

19. The method as recited in claim 15, wherein constructing the adjacent components comprises constructing the inducer body formed of a material having a higher coefficient of thermal expansion than the motor protector housing.

20. The method as recited in claim 10, wherein protecting the motor protector from the heat generated by the thrust bearings via an enhanced cooling system further comprises using a motor lead extension slot formed along the motor protector housing to accommodate a motor lead extension when expanding a diameter of the motor protector housing to a maximum diameter of the electric submersible pumping system so as to increase an effective heat transfer area of the motor protector housing.
